(19) United States
(12) Patent Application Publication
(10) Pub. No.: US 2004/0078476 A1
(43) Pub. Date: Apr. 22, 2004

(54) System and method for maintaining special purpose web pages

(76) Inventors: Allen M. Razdow, Cambridge, MA (US); Deepak Karamcheti, Massachusetts, MA (US); Daniel R. Slater, Manchester, NH (US); Michael S. Stout, Somerville, MA (US)

Correspondence Address: Weingarten Schurgin, Gagnebin & Lebovici, Ten Post Office Square, Boston, MA, 02109, US

(21) Appl. No.: 10/470,962

(22) PCT Filed: Feb. 8, 2002
(86) PCT No.: PCT/US02/03724

(51) Int. Cl. G06F 15/16

(52) U.S. Cl. 709/229

(57) ABSTRACT

A system and method for generating and maintaining special purpose web pages which are associated with access lists of web page visitors. The system provides access to contact information, and other types of information, based on the access lists. The disclosed system further enables web page owners to control access to information provided through the web page on a group or individual visitor basis. In an illustrative embodiment, the special purpose web pages disclosed herein are “contact web pages” which provide contact information relating to the web page visitors to contact web page owners. The disclosed system may be used to provide personal contact web pages for individual and/or business specific contact web pages for business entities.

### CROSS REFERENCE TO RELATED APPLICATIONS

This application claims priority under 35 U.S.C. §119(e) to provisional patent application serial No. 60/267,675 filed Feb. 9, 2001.

### STATEMENT REGARDING FEDERALLY SPONSORED RESEARCH OR DEVELOPMENT

N/A

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

The disclosed system relates to generating and maintaining special purpose Web pages which enable a Web page owner to control how information is made available to various users or groups of users through the Web page. The disclosed system relates more specifically to generating and maintaining “contact Web pages”, which are each associated with a person or business entity referred to as the contact Web page “owner”, and which are used to distribute contact information regarding their respective owners.

As it is generally known, the World Wide Web includes many thousands of Web sites that may be accessed by Web users to obtain various kinds of information. For example, a typical corporate Web site may be used to provide information regarding a company, such as product offerings, services, and/or contact information. The contact information displayed or listed through such a Web site may consist of addresses, FAX and telephone numbers, and/or email addresses. Some existing Web sites further enable a visitor to leave a phone number so that the visitor can be called back at a later time. Often, contacts resulting from accesses to typical existing Web sites consist of ordinary phone calls placed to a number or numbers obtained from the site, or sending an email message through email technology external to the site.

Additionally, in existing systems, there is no convenient mechanism or technique for automatically creating the login and customization capabilities of web pages. Moreover, providing and maintaining information associated with external contact mechanisms may require significant custom development, integration, and maintenance by staff assigned to build and operate the site.

For the reasons stated above, it would be desirable to have a system for generating a web page for an individual or business, which operates such that the generated web page facilitates the provision of contact information and/or automated contact mechanisms related to that individual or business. The web page should enable the customized delivery of contact information to individual visitors and/or callers. The system should effectively automate the use of such contact information provided to visitors of the web page. Contact mechanisms provided through the web page should enable selective connection to the associated individual or business, and potentially maintain contact information used by such contact mechanisms such that it is hidden. Moreover, the system should enable a Web page owner to conveniently define the users who may access specific information available through the Web page, as well as the way information is presented through the Web page, on a user by user and/or user group basis.

### SUMMARY OF THE INVENTION

Consistent with the present invention, a system and method are disclosed for generating and maintaining special purpose Web pages. The disclosed system generates special purpose Web pages, and assigns access lists to Web page visitors. The system provides access to contact and other types of information based on such access lists. The disclosed system enables Web page owners to specify how content provided through the web page can be accessed on a group or individual visitor basis. In an illustrative embodiment, the special purpose Web pages disclosed herein are “contact Web pages” which provide contact information and/or automated contact mechanisms which may be used to contact the Web page owner in a manner defined by the contact Web page owner. Examples of automated contact mechanisms include “soft-switched” telephone calls, electronic mail, and/or instant messaging, and others. In this way, the disclosed contact Web pages enable contact Web page visitors to contact Web page owners and/or obtain access to customized, user and/or user group specific content information defined by the owner of the contact Web page. The disclosed system may be used to provide personal contact Web pages for individuals and/or business specific contact web pages for business entities.

Advantageously, the disclosed system may be embodied such that it acts as a “contact broker”, in that it facilitates the transparent connection of a contact Web page visitor to a contact Web page owner. Accordingly, the contact Web page may be used to control contact between contact Web page visitors and the contact Web page owner based on contact parameters provided by the contact Web page owner. Specifically, an embodiment of the disclosed system may allow a contact Web page visitor to contact a contact Web page owner, while hiding the actual contact information used from the Web page visitor. Thus the contact Web page enables a contact Web page owner to maintain contact information such as telephone numbers, fax numbers, and/or email addresses as private information. Moreover, the contact Web page owner is further enabled to define and control by whom and at what times such hidden contact information may be used to attempt to contact the contact Web page owner.

### BRIEF DESCRIPTION OF THE SEVERAL VIEWS OF THE DRAWINGS

The invention will be more fully understood by reference to the following detailed description of the invention in conjunction with the drawings, of which:

FIG. 1 is a flow diagram illustrating steps performed in an illustrative embodiment;

FIG. 2 is a block diagram illustrating the operation of the disclosed system;

FIG. 3 shows a block diagram further illustrative of system operation;

FIG. 4 shows an example of a Web page contained within an owner's interface to the disclosed system;

FIG. 5 shows an example of a management Web page, accessible as part of the owner's interface, and which enables access to management functions for the contact Web page owner;

FIG. 6 shows a contact page within the owner's interface;

FIGS. 7A and 7B show an example of a Web page within the owner interface that enables editing of properties for an access list;

FIGS. 8A and 8B show a Web page with the owner interface that enables editing of properties for a location;

FIG. 9 is an example of a Web page that serves as a reception page within the visitor's interface;

FIG. 10 shows an example of a reception page; and

FIG. 11 shows an example of a Web page in the owner interface which provides access to properties associated with a directory.

### DETAILED DESCRIPTION OF THE INVENTION

All disclosures of Provisional U.S. patent application 60/267,675 are hereby incorporated by reference herein.

Contact Web Page Generation

The term Web page, as used herein, refers to a World Wide Web document. A Web page is generally a text file coded in HTML, which may also contain various kinds of script, such as JavaScript code. A “contact Web page”, as referred to herein, is one or more Web pages which provide a personalized experience to a user or group of users in response to a self-identification process. Such an identification process may, for example, include steps in which a visitor to the contact Web page provides certain login information that is used to determine a customized view to be provided to that visitor.

In an illustrative embodiment, the disclosed contact Web pages are generated by a contact Web page generation process which is specifically designed for generating such special purpose Web pages. Once generated, each contact Web page may be used by visitors to contact the owner of the special purpose Web page. In one embodiment, the disclosed system enables telephone calls to be connected between a visitor and a Web page owner through selection by the visitor of a hyperlink. For example, such calls may be connected through what is referred to as “soft switch” technology, which automatically connects telephone calls by ringing telephones of both the Web page visitor and the Web page owner. In this way, the actual phone numbers of the Web page visitor and Web page owner need not be exposed to the other party. Such phone calls may be provided using normal phone lines, or by using bandwidth provided over the Internet.

The disclosed Web page generation and maintenance system further includes a number of features that assist contact Web page owners with regard to their contact Web pages.

Owner Interface and Features

The disclosed system includes an owner interface for use by the contact Web page owner. The owner interface embodies a number of specific user interface attributes, including:

1. Controlling Web page Owner notifications. The contact Web page owner interface allows a contact Web page owner to control the delivery of notifications and other information through the contact Web page in connection with the following:

a. Defining contact owner contact information. In an illustrative embodiment, the contact Web page owner interface allows the contact Web page owner to configure the way locations and associated times for contacting the Web page owner at such locations are provided through the contact Web page. The disclosed system allows a contact Web page owner to define multiple locations. Each location can be associated with phone numbers for phones available at the location, as well as other properties like location name, and times at which the owner will be at the location. The times at which an owner plans to be at a given location may, for example, be selected by the Web page owner from a menu including menu items such as “never,” “always,” “weekdays,” “weekends,” “Monday,” “Tuesday,” etc. A time may also be specified by the Web page owner, such as “weekdays from 9 am to 5 pm.” For each visitor or group of visitors, the Web page owner can define a) whether location information for the owner, such as a current location, will be made available, b) a subset of locations at which the owner can be accessed or contacted, and/or c) a subset of contact mechanisms, such as a primary phone, through which the owner can be contacted at one or more locations. Moreover, the contact Web page owner interface allows the owner of a contact page to dynamically disable various contact mechanisms, such as phones, for example during certain times or dates.

b. Posting of personalized messages. The disclosed system further enables the Web page owner to leave customized messages for specific visitors or groups of visitors. This feature eliminates the need for a contact Web page owner to leave a single message that all visitors can access, as would be necessary when using a conventional telephone answering machine. Thus the disclosed system may be used to provide custom publishing to self-identified, source independent callers who have placed a call through the Web page, and/or visitors to the Web page.

The disclosed system may enable a contact Web page owner to indicate that a message should be shown some limited number of times, and/or for some limited time period. In such an embodiment, a contact Web page owner may indicate that a message should be shown to a specified visitor or group of visitors, and may specify that the message should only be shown once to each visitor. In this way the disclosed system may be used to control the number of times and/or duration over which a message should be displayed to an individual or workgroup. Similarly, the disclosed system may provide duration control over the provision of contact Web page owner location information to contact web page visitors.

c. Identification of Web page visitors. The contact Web page owner may configure the contact Web page such that the contact Web page owner is notified, through the owner interface, of all visitors to the contact Web page that have either registered or logged in.

d. Receiving messages from Web page visitors. The contact Web page owner may be presented with messages posted by visitors to the contact Web page through the owner interface.

e. Maintaining a history of calls/contacts placed through the Web page. The disclosed system may be used to keep track of incoming caller ID's or Internet addresses associated with contact Web page visitors, in order to send out advertising information, for example in the form of electronic mail. Such history may be configured and/or accessed through the owner interface.

2. Defining a Content Access Hierarchy. The disclosed system permits the contact Web page owner to define the access hierarchy for content provided through the contact Web page.

a. In an illustrative embodiment, content access is defined with regard to contact Web page visitors that are 1) anonymous, in that they have not registered or logged in, 2) registered, in that they have provided some information regarding their identity to the system, or 3) categorized, in that they are placed or contained in a named access list associated with a specific set of access attributes applicable to all visitors within the list. For example, a “trusted” property may be one of the attributes which a contact Web page owner may associate with either an individual visitor or a named list of visitors defined by the contact Web page owner. Those visitors that are individually associated with the “trusted” property, or that belong to a named list associated with the “trusted” property, may be permitted a relatively high level of access to content provided by the contact Web page owner through the contact Web page. Such named lists may be defined and maintained, for example, through folder constructs provided through the contact Web page owner interface. In one embodiment, anonymous visitors are treated as a category of visitors having an associated set of access attributes.

In other words, contact Web page visitors may register with the system to access features that the owner defines as accessible to registered visitors. Additionally, contact Web page visitors that are registered may login to the system. Of those visitors that have successfully logged in to a contact Web page, certain ones may be defined in this way by the Web page owner a priori as being trusted, in that they have access to certain predefined content provided by the Web page owner.

b. Manipulating the contents of the People folder. Visitors that have registered with the contact Web page, and/or attempted to contact a contact Web page owner, will be identified to the contact Web page owner, for example, through a listing in a “People” folder within the contact Web page owner interface. Moreover, a message entered by a registered visitor may also be presented through an entry in the People folder, or within another special purpose folder of the contact web page owner interface. Along these lines, the People folder may be used to store indications of visitors that have registered with the contact port generation site or a contact Web page, but have not been previously identified and/or categorized as potential callers having associated access attributes by the contact Web page owner. In an illustrative embodiment, named lists of visitors are supported through the People folder by sub-folders associated with specific content access levels defined by the contact Web page owner. For example, a specific level of access might be allowed to some subset of people within the People folder that are considered to be trusted by the contact Web page owner. When the contact Web page owner reads the contents of the People folder, he/or she can then conveniently move certain visitors into such a “higher access level” sub-folder. Thereafter, the visitor moved into such a sub-folder would be provided the associated higher level of access after they log-in to the contact Web page. For example, information available to visitors associated with such higher level access attributes might include all locations and/or mechanisms (phones, faxes, e-mail, etc.) that might be used to contact the owner of a contact Web page. Another subfolder within the People folder may be used to define another access level for those visitors that may be shown a “current” location where the system believes the owner of the contact Web page is currently located.

As described above, the contact Web page owner interface of the disclosed system may be embodied such that access rights can be conveniently defined for anonymous visitors. Additionally, the contact Web page owner interface further may operate such that registered visitors are displayed in a predetermined folder when they first access the contact Web page. The visitors that automatically appear in this predetermined folder may be thought of as self-identified visitors, since they have provided identification information to the contact Web page. The predetermined folder may be embodied as a “People” folder. Other folders may further be provided for and/or defined by the contact Web page owner, in order to associate certain access rights with visitors contained within such folders. Moreover, the contact Web page owner interface further enables the contact Web page owner to customize the access rights on an individual visitor basis in a way that overrides any access rights associated with folders containing that individual.

The contact Web page owner interface further includes features which allow a contact Web page owner to create directories of users. Such directories may be viewed and potentially modified by contact Web page visitors on a selective basis, for example through directory Web pages within or otherwise linked or associated with the contact Web page, based on the access rights applicable to a each visitor. Accordingly, a given directory may only be viewable by some predetermined set of visitors. The entries in a directory may be linked to either a contact Web page, or to an actual phone number. Moreover, such directory entries may, for example, be indexed according to user names. Accordingly, after searching such a directory for a given name, if that name is located within the directory, the directory user may click on the associated directory entry to be switched over to the contact Web page associated with the located name, or to be automatically connected with the user, for example through hidden contact information associated with the name, such as a telephone number. The contact Web page owner may further explicitly control whether or not visitors may modify their own entries in a directory.

In another aspect of an illustrative embodiment, a contact Web page owner may create and/or maintain a “workgroup” of visitors to the contact Web page. Members of such a workgroup may, for example, be associated with a billing code or party which is responsible for payment of all or some of the actions performed by members of the workgroup with respect to the contact Web page.

Visitor Interface and Features

The disclosed contact Web page visitor interface includes various features.

1. Reception Pages.

The visitor interface to a contact Web page may include one or more reception pages. A reception page is a Web page any visitor can initially access when they want to reach a contact Web page owner. Reception pages may have URL's like http://acall.to/user/username.html, which make it easy to email them, save them as favorites, or incorporate links to them in a Web site. When a visitor visits a reception page, the visitor can do so anonymously, or the visitor can respond to an invitation to register for a username. If a visitor has registered and logged in, the disclosed system can operate in response to the visitor's identity. Contact Web page owners can customize their reception pages to show different things to different visitors.

In an illustrative embodiment, when a visitor is ready to click on a phone link on a reception page, the following steps are performed:

a. The visitor is prompted to enter his or her own phone number into a window of the user interface. Once entered, the number may be stored so that the visitor doesn't have to type it in the next time he or she places a call.

b. The visitor clicks to complete the call, and within one or two seconds, the visitor's phone rings.

c. The visitor answers the ringing phone, and hears a recording of an announcement such as the following: “Please hold for your connection . . . ” followed by the usual sound of the other phone ringing. At this point, the phone call is underway just as if the visitor had dialed the other phone number.

2. Web Page and/or Web Page Owner Directories.

Directories of Web pages are a powerful tool of the disclosed system that may be provided through the web page visitor interface. Visitors to a given contact Web page may be provided access to one or more Web page or Web page owner directories. Accordingly, a user may find one of the disclosed contact Web pages either by being invited, such as through an email message from the Web page owner, or by searching through a directory database. Such a directory database may be provided by the Web page generation site, or through a type of virtual “phone book” that would list contact web pages by various attributes of the contact web pages.

Directories may also link certain entries to contact information such as telephone numbers. Accordingly, clicking on a given directory entry may result in displaying of another contact web page, while clicking on another entry may result in the system directly making a call to an associated telephone number, wherein the telephone number itself used to place the call may be kept hidden from the directory user.

3. Visitor Registration or Logging In.

In an illustrative embodiment of the disclosed system, login information may be used by a visitor to trigger different access priorities with regard to content provided through a given contact Web page. Such login information may include a visitor ID, user ID, user name, and/or password. Each contact Web page may generate different content to different visitors based on caller IDs entered into the system. For example, a database may be provided for each contact Web page that associates specific actions with caller IDs. The specific actions associated with a given caller ID are modifiable by the owner of the contact Web page. In order to provide authentication, a contact Web page visitor may be required to provide a password along with the caller ID during a login procedure. As an alternative to an explicit login procedure, information stored within a contact Web page visitor's “cookie” may be used to authenticate the visitor, and to trigger the actions associated with a given caller ID as indicated by the contents of the database. Accordingly, within the cookie environment, parameters identifying the caller may be inserted by the client system into the URL of an HTTP request. In this way such visitor authentication information would thus be transmitted from the client to the server.

The accessibility of features provided through the Web page visitor interface is determined according to the hierarchical access levels associated with specific items of content. In an illustrative embodiment, in a first visitor interface screen of a contact Web page, the view provided to an anonymous visitor is defined by the contact Web page owner. The owner of each contact Web page may therefore define properties associated with a reception page of the contact Web page to be applied for an anonymous visitor to the contact Web page. When an anonymous visitor is accessing the contact Web page, the disclosed system may ask the visitor to register. Registration triggers another content access level that may be customized by each contact Web page owner to define content access beyond that provided for anonymous visitors. Such “registered user” access is analogous to the access that might be provided to a visitor in an office that has provided a name to a receptionist. Additionally, once a system user is registered, that user's identification information may be automatically obtained by the contact Web page when the user browses that Web page, through what is conventionally referred to as a “cookie” technique.

4. Posting Messages.

Contact Web page visitors may be allowed to post messages to the owner of the contact Web page. The ability to leave messages may be provided to all visitors, registered visitors, and/or only certain predefined visitors defined by the contact web page owner.

A visitor screen in the visitor interface may reflect the current location of the contact Web page owner in how it presents the current contact options. For example, a trusted visitor who has successfully logged in may be shown the contact options in an order that reflects the most likely places at which the contact Web page owner is currently located. In addition, personalized message information may be presented to any of the various groups of invitees, or to individually identified invitees, as defined by the contact Web page owner. The message information may include any type of contents, such as links, text, multi-media etc.

Other Features

1. Call Control Features.

The present system includes call control features for putting callers on hold, performing call transfers, enabling a caller or callee to hang up and redial, as well as muting functionality. Such features may be provided through the contact Web page owner interface, and/or through the visitor interface(s) to a contact Web page.

In particular, the disclosed system may include an instant messaging feature that provides electronic messaging in parallel with the placement and/or reception of telephone calls. Such simultaneous instant messages may be used to indicate the subject matter of a pending call (e.g., while the phone is ringing), or the person that is placing a call that has not yet been picked up.

For example, if a contact Web page owner is logged in, an on screen announcement may be provided indicating that one or more predetermined users are browsing the contact Web page. Similarly, the disclosed system may use its embedded contact information regarding the contact Web page owner to notify the contact Web page owner that someone is trying to reach the contact Web page owner, or that someone is browsing the contact Web page. In the case where a visitor to the contact Web page has clicked a contact link, while the contact Web page owner's phone is ringing, the system may provide information to the contact Web page owner regarding the identity of the caller, and/or any message that the caller has provided that is associated with the pending call. Such information may be used by the callee in order to determine whether to accept or reject the pending call.

The disclosed system may further include a feature which permits a participant in an active call to make another call without having to hang up on the first call. In such an embodiment, another number is automatically dialed by the underlying system. When the third party picks up, the third party is automatically added to the current active call, or the original user may put the first call on hold while connecting with the third party. In this way, multiple calls may be brought up at once, and some number of those multiple calls may be automatically or expressly merged into a conference call. In this way the disclosed system enables call transfer and/or setting up of a conference call, and further enables dropping out of a conference call once it has been set up. Moreover, the disclosed system may be used to provide all advanced PBX features under World Wide Web interface control.

2. Voice Enablement Features.

The present system may further include a variety of voice enablement features which may be used to make various visually provided features also available through voice commands or via a key pad interface. In this regard, the disclosed system may provide functionality for translating some or all of the visually triggerable features to audio information, in response to voice or keypad commands. As a result, the disclosed system may be triggered at a feature level either by voice or telephone key pad originated commands.

Along similar lines, integration of the disclosed system with an automated call attendant is also possible. In such an embodiment, the automated call attendant is enabled to perform speech to text translation in order to generate HTML code, or other types of text, such as might be used to convey message information either to a web page visitor or a web page owner. Additionally, such an embodiment may perform text to speech translation from HTML or text sources, in order to provide messages to visitors and/or web page owners through a variety of communication channels. Similarly, interfaces to the disclosed system may include features which support voice recording, such as the owner interfaces or the visitor interfaces. This capability may be referred to as “voicification” of the features of the disclosed system. Such voicification of the interface screens could be sufficient to allow complete use of the system through a key pad or over a telephone.

Voice messaging may also be used in connection with the disclosed system such that recorded speech messages are converted to text, in order to deliver a message that was originally provided as voice data in a text form. Similarly, a voice message may be created from a message that was originally entered as text. In one embodiment, a sound icon may be attached to a message to enable the message recipient to access a previously recorded voice message. Additionally, contact web page owners may provide audio messages for selective ones or all callers and or visitors to the contact web page. Such functionality enables access to voice messages initially provided through a telephone, or in connection with the use of a browser, and advantageously enables the system to aggregate voice message collected at various numbers for a given contact web page owner.

3. Customized Content Delivery.

The disclosed system may be used to provide visitor and/or caller specific content delivery and/or publishing. In an illustrative embodiment, multiple types or classes of content may be delivered from a visitor or caller to an owner of a contact web page. Similarly, various types or classes of content maybe delivered through an owner's contact web page to selected visitors and/or callers. Such content types may include pictures or other types of graphic information. In an illustrative embodiment, the contact web page owner may associate specific content with one or more folders defined within the contact owner interface, wherein such folders define groups of potential visitors to the contact web page. In addition, certain content may be defined as accessible through the contact web page to all visitors and/or callers. The disclosed system, thus conveniently provides visitor and/or caller specific content delivery. Moreover, various specific user interfaces may be provided to support the provision of different content types to either callers or visitors, or to the contact web page owner. In other words, an editor may be provided either to visitors or the contact web page owner which would enable the creation of links (“hyperlinks”) within messages that are passed in either direction.

4. Pricing and Charging Related Features.

Various pricing and charging schemes may be employed with the disclosed system, which enable charging based on work groups or individual members that are associated with certain user actions. For example, the disclosed system may be embodied to include the ability to apply charges to a caller who places a call to a contact web page owner. In this way, the disclosed system may assess charges for telephone time to users of the telephone service. The disclosed system may further include functionality which enables telephone calling charges to be assessed to contact web page owners.

The disclosed system may further be embodied such that feature level pricing is enabled. Such feature level pricing may assess charges based on which specific features are used by either a visitor, caller, and/or contact web page owner. Additionally, the disclosed system may enable charges to be accessed to credit cards, telephone calling cards, purchased orders, and/or specific telephone numbers.

In one embodiment, the disclosed system enables a user to indicate a party to whom a specific call or other feature charge should be billed to. Such an indication may, for example, be provided through the use of a predetermined billing code, which may be selected through a point and click operation. For example, moving of a selected billing code to a specific folder within the interface may indicate party to be billed for a call or use of some other feature. In this manner, a corporate approved list of operations and/or features that may be charged to a given corporation may be used to verify and/or facilitate charging of operations and/or features to the corporation by some predetermined set of users. Tracking of charges made through the disclosed system to the corporate account, for example related or to certain users or phones associated with corporation, may thus be used to automate expense accounting related to those users or phones. Such a feature would effectively automate the generation of expense reports based on tracking of system feature use, such as placement of telephone calls through the system.

Directories and sub-directories of callers and/or contact web page owners may be used to enable a party to become a reseller of features or functionality provided by the disclosed system. Such a reseller may provide features from the disclosed system in connection, for example, with a service such as a dating service. In such a scenario, a membership directory may be provided through interfaces accessible to members of the service. The directory entries can then be used by service members to place secure calls such that no phone numbers are seen by either party. The disclosed system also enables call tracking on a phone book wide basis to determine what percentage of overall system use can be attributed to certain directories in terms of callers and/or contact web page owners. Such directory usage information can then be used to determine billing levels based on directory usage. In other words, a percentage of over all usage may be assigned on a directory basis for purposes of allocating costs and/or expenses.

The disclosed system may further provide a form of operation in which callers are restricted to calling persons within one or more pre-indicated directories. In this way the directories employed by the disclosed system define communities of users. Customers of a feature reseller are allowed to access directories for those communities that they have paid to belong to. In addition, aggregated communities consisting of multiple directories, may be used to build bridges between companies in order to conveniently connect the directories of different companies.

Further Description of the Illustrative Embodiment

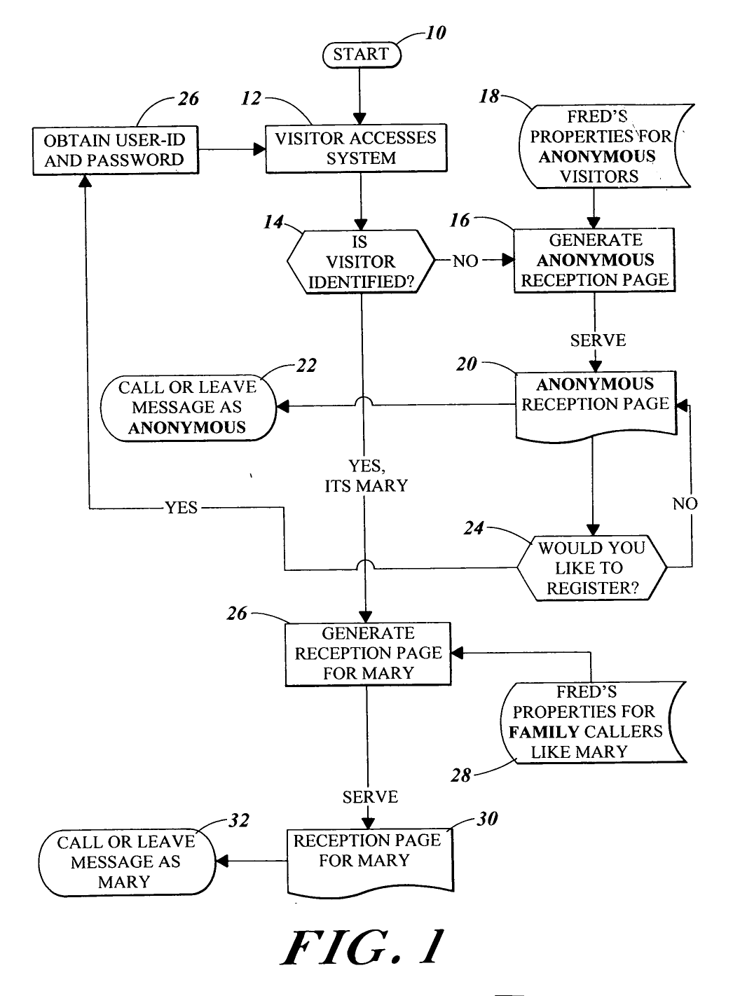

FIG. 1 shows a number of steps performed in an embodiment of the disclosed system. FIG. 1 illustrates a contact web page visitor visiting a contact web page for Fred. FIG. 1 further illustrates steps related to processing a web page visitor that is known to the system (“identified”), or a web page visitor that is anonymous. FIG. 1 also includes steps relating to registration of a previously unregistered contact web page visitor.

At step 10, a visitor begins the set of steps shown in FIG. 1. Following step 10, at step 12, the visitor accesses a contact Web portal, referred to for purposes of illustration as Fred's contact Web page, where Fred is an owner of the contact Web page. At step 14, the system determines whether the visitor is identified. If not, then at step 16 the disclosed system generates a reception page associated with anonymous visitors. The anonymous reception page generated at step 16 is responsive to the properties defined by the contact Web page owner at step 18. Following step 16, at step 20, the disclosed system displays the reception page generated at step 20. The reception page displayed at step 20 enables the visitor to call or leave a message as an anonymous visitor at step 22, as well as prompting the visitor to register at step 24. If the visitor indicates that they would like to register at step 24, then step 24 is followed by step 26, in which the visitor registers and is provided with a user name and password.

At step 26, the disclosed system has determined, for example through login information, that the current visitor is Mary. Accordingly, at step 26, a reception page is generated for Mary that is responsive to a set of properties associated with a named group of visitors referred to for purposes of illustration as “Family callers,” and entered by the contact Web page owner at step 28. The reception page generated at step 26 is then displayed at step 30, and enables the visitor Mary to access contact information and mechanisms, or content, that is accessible to the Family callers group at step 32.

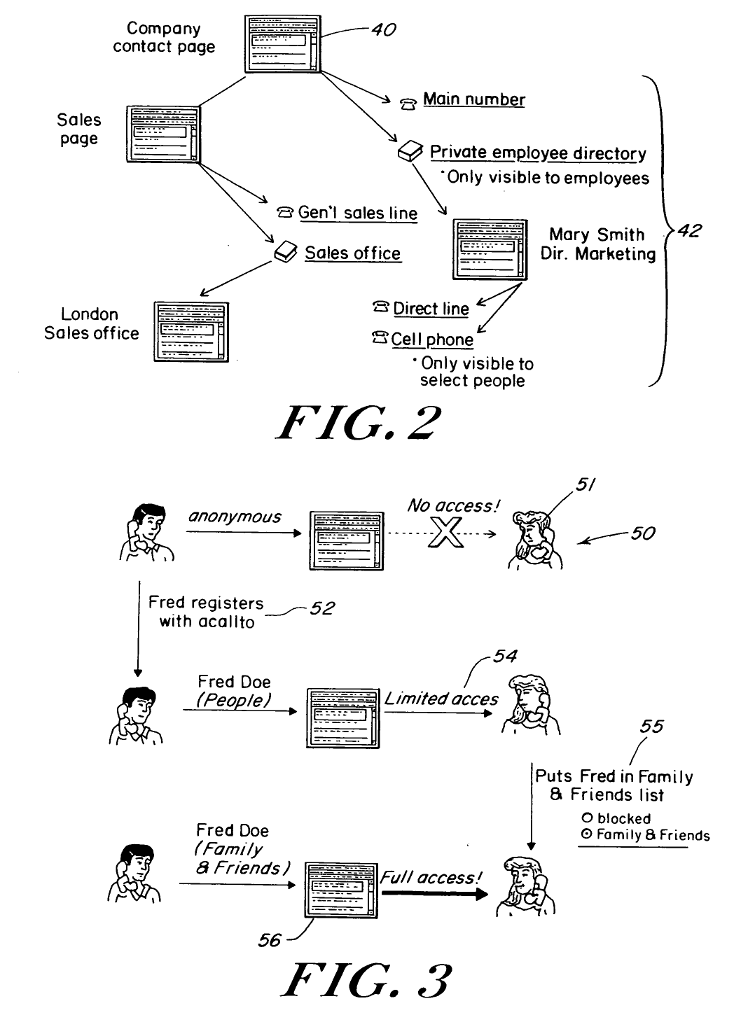

FIG. 2 illustrates the operation of the disclosed system. The disclosed reception pages and directories of the disclosed visitor interface are building blocks that may be used to integrate communications into a website. For example, a reception page 40 may serve as the company contact Web page. Through the reception page 40, various other specific contact information 42 relating to the company may be provided. The contact information 42 may include various contact Web pages of people or departments, which may conveniently be directly configured and/or maintained by the respective people or departments themselves using the disclosed system.

FIG. 3 shows an illustrative example of system operation. At step 50, a user Fred is denied access to a contact Web page owned by another user 51. At step 52, Fred registers with the disclosed system, which enables Fred to get limited access to the desired contact Web page at step 54. The user Fred has contacted through the contact Web page at step 54 then enters Fred into a higher level access group at step 55, which enables Fred to access the various information associated with the higher access level at step 56. In this way, Fred gets increasing levels of access to the person he's calling by registering, then by being placed in a high level access list.

As disclosed herein, a key aspect of the system is caller identification obtained from reception page visitors being asked to register and log in. This may accordingly result in three progressive levels of identification of callers visiting a reception page:

Anonymous: An unregistered caller, or one not logged in, is identified by the system as anonymous. Anonymous visitors are encouraged to register but can remain anonymous if they wish to. Contact Web page owners can set how little or how much access they wish to give anonymous callers. For example, a famous contact Web page owner may give anonymous callers no access to themselves, or offer a phone link to a fan club or recorded message.

People: When a registered caller first accesses a reception page, he or she is automatically added to the owner's general People list. This is a step up from being an anonymous visitor, because the visitor can be specifically identified by username. Contact Web page owners can separately set access properties for People, for example offering more access than to mere anonymous callers.

Listed: Contact Web page owners can create access lists representing different levels of access to content provided through the Contact Web page. For example, a Web page owner might create a “no access” list for visitors they don't want to hear from, and a “family and friends” list for visitors they're always glad to hear from. As new visitors show up in their People list, owners can move them to these custom lists depending on their preferences.

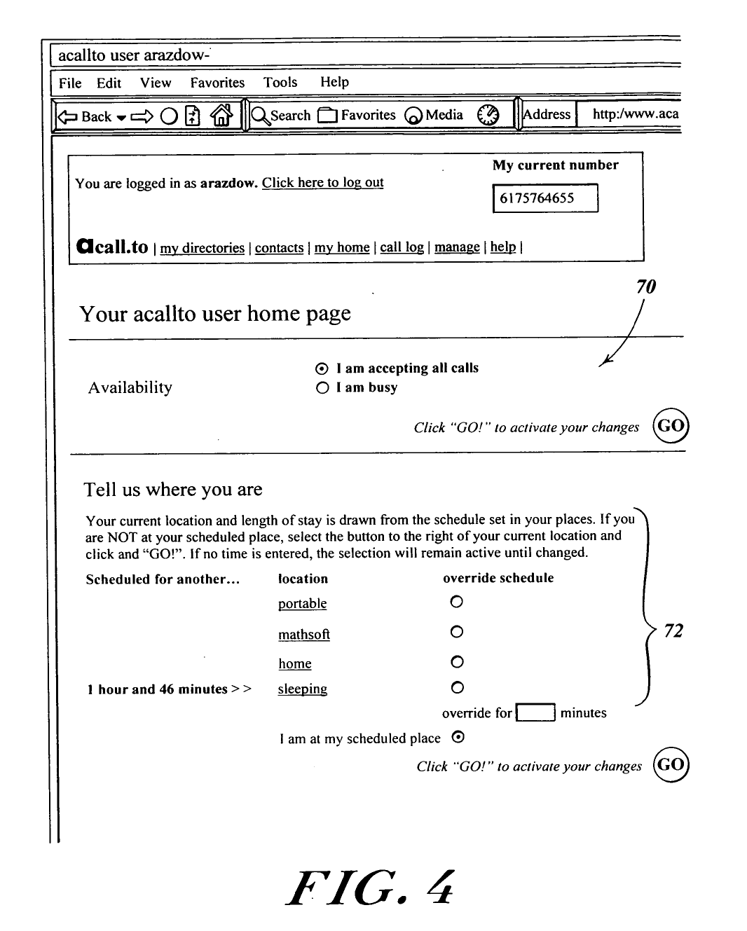

FIG. 4 shows an example of a Web page contained within an owner's interface to the disclosed system. Through the Web page in FIG. 4, the contact Web page owner can use the availability interface 70 to designate themselves as busy or available, and/or the current location interface 72 to view which location they are scheduled to be in, and to override such location information.

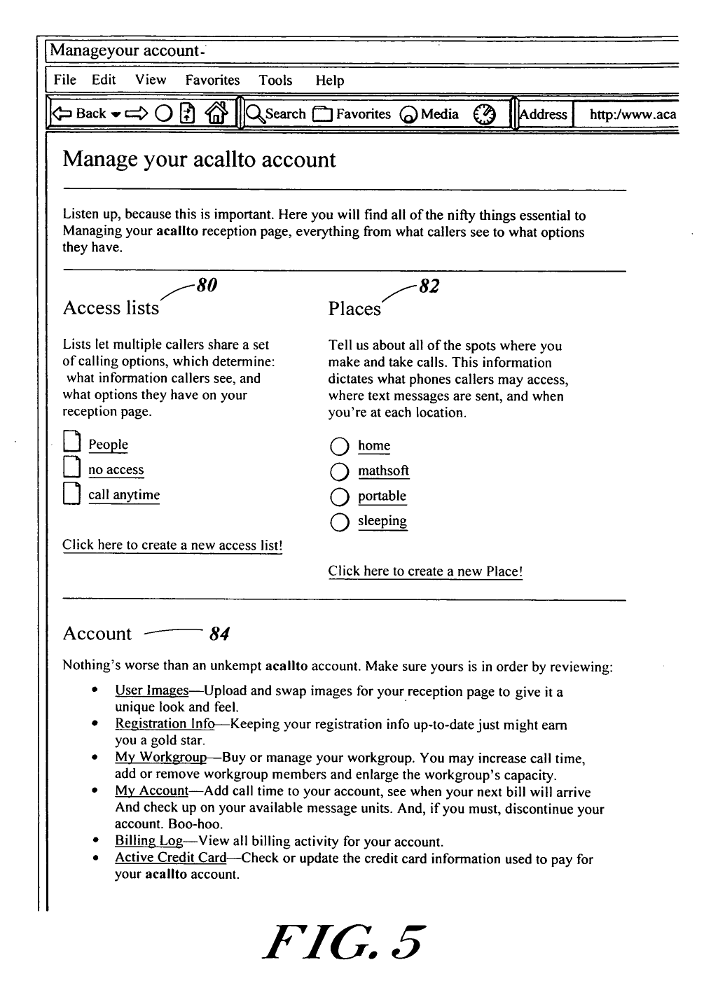

FIG. 5 shows an example of a management Web page, accessible as part of the owner's interface, and which enables access to management functions for the contact Web page owner. An access list interface 80 enables creation, viewing and editing of access lists and their properties. A location interface enables creation, viewing and editing of location information and properties. Additionally, an account interface 84 enables branching to pages for uploading graphics, managing billing, etc.

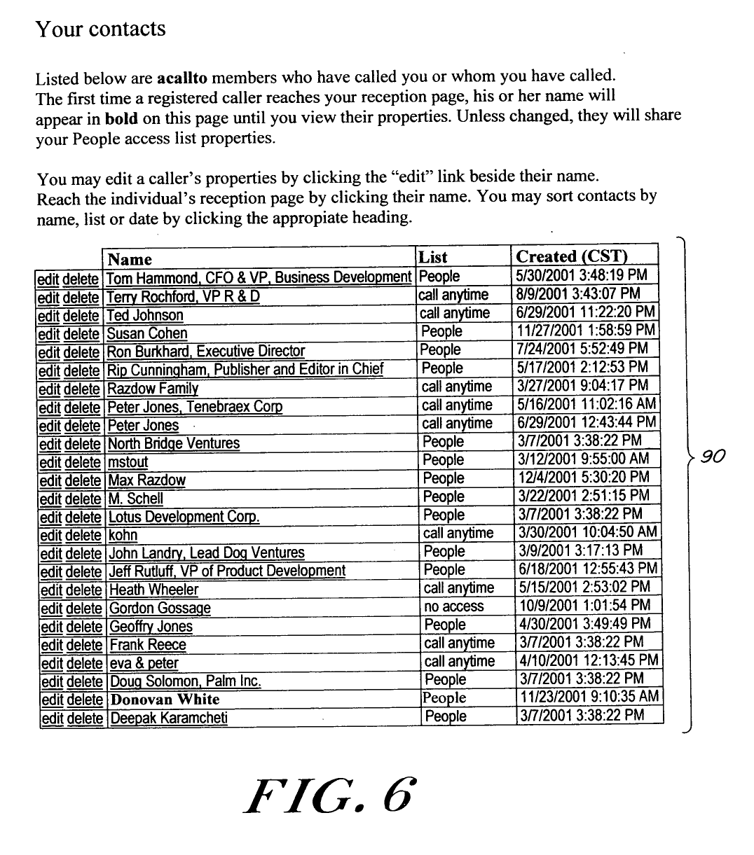

FIG. 6 shows a contact page within the owner's interface, that stores those identified visitors 90 that the owner has communicated with. Those in boldface within the list 90 are new contacts, put in the “people” access list by default. By editing their properties, visitors in the list 90 can be assigned to other access lists. In the example of FIG. 6, contacts are present in the “call anytime” and “no access” lists as well as “people”. By clicking on the name of the contact, the owner can initiate a call to them.

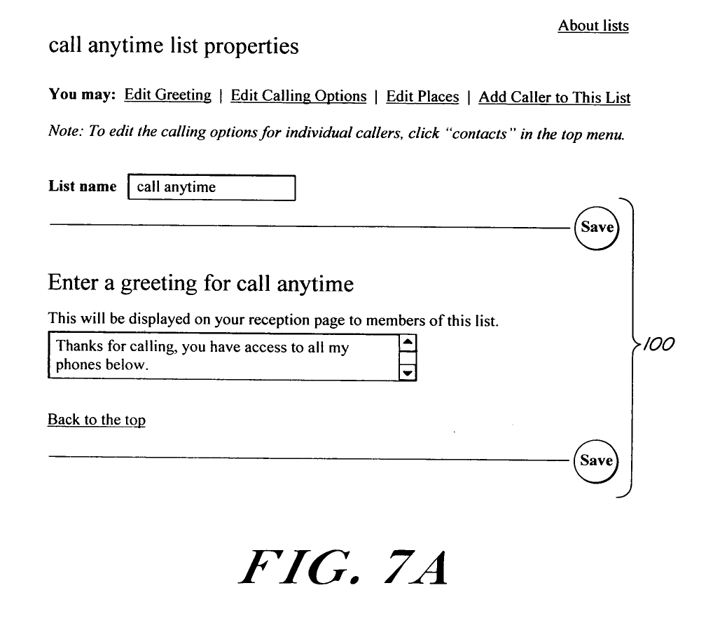

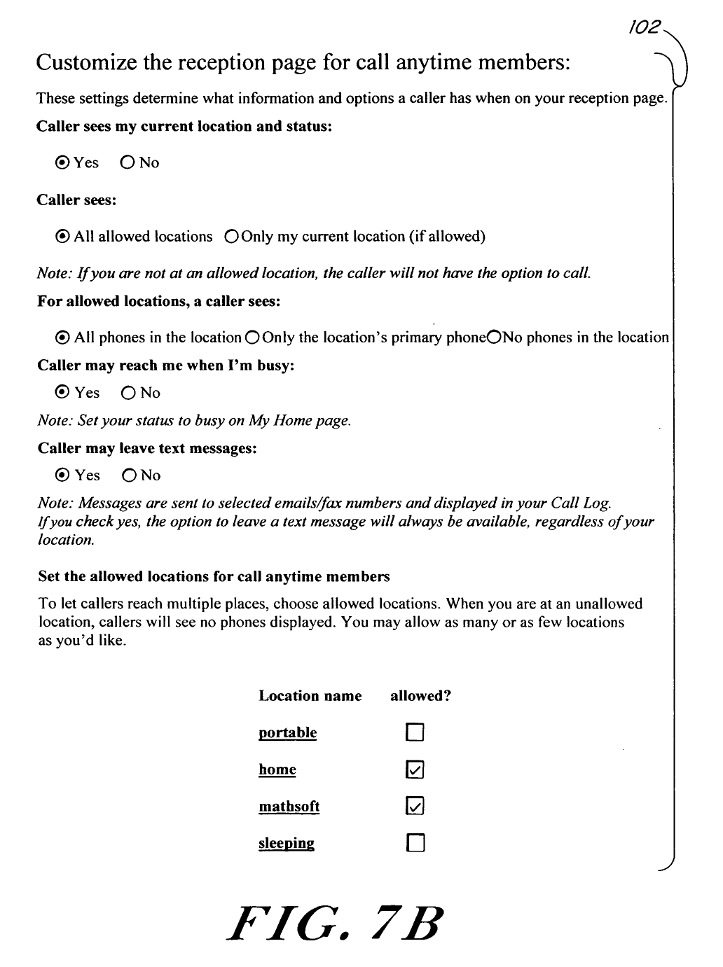

FIGS. 7A and 7B show an example of a Web page within the interface that enables editing of properties for an access list called “call anytime.” The interfaces to properties that can be edited through the Web page in FIGS. 7A and 7B include the reception page greeting interface 100, and other reception page properties 102.

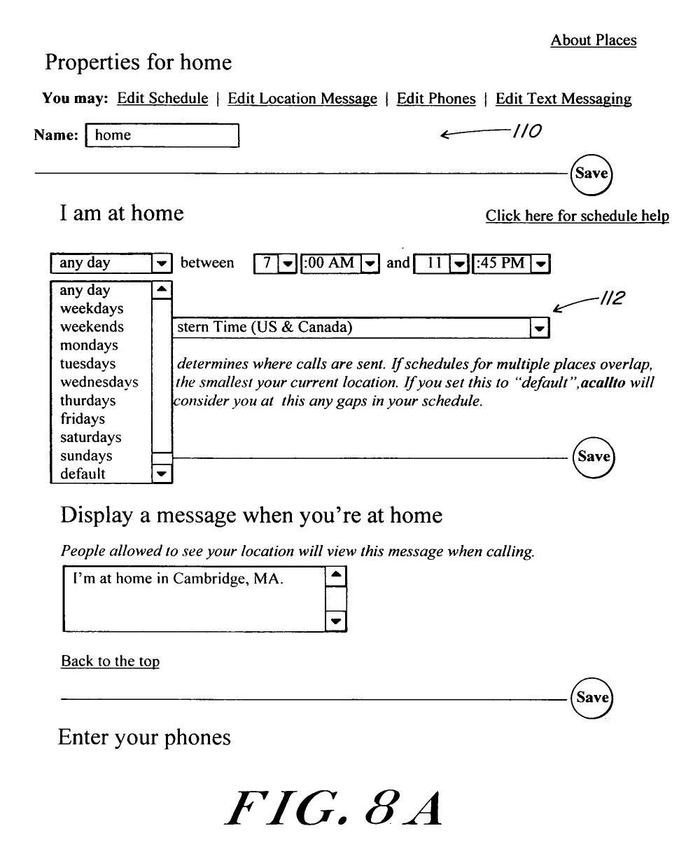

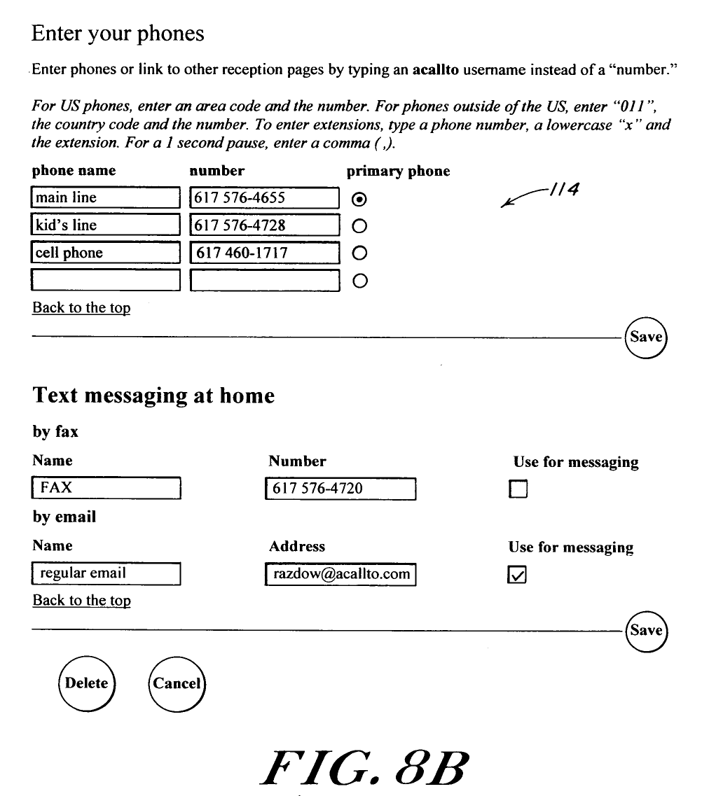

FIGS. 8A and 8B show a Web page with the owner interface that enables editing of properties for a location called “home”. The Web page in FIGS. 8A and 8B provides the owner within an interface 110 to enter how that location will be identified to visitors, an interface 112 to enter what days and times the owner expects to be there, and an interface 114 to enter what phones are available at that location, and other interfaces.

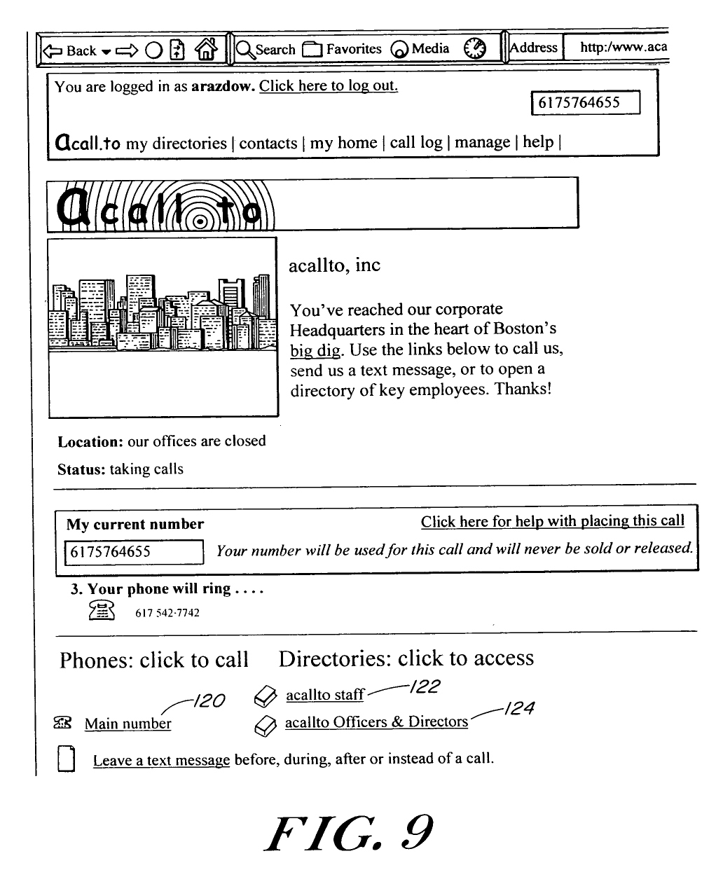

FIG. 9 is an example of a Web page that serves as a reception page within the visitor's interface. As shown in FIG. 9, a visitor (username arazdow) is logged in, and accessing the reception page for acallto inc. The Web page of FIG. 9 includes a link to call a main number associated with the owner, as well as links to directories 122 for staff and 124 for directors.

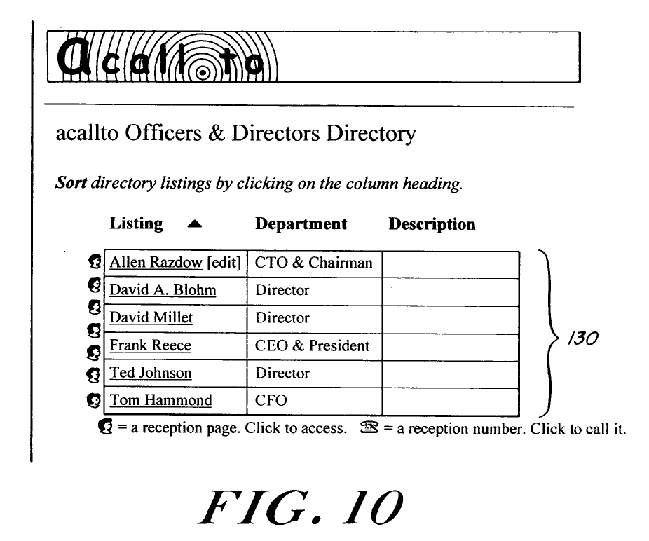

FIG. 10 shows an example of a reception page, for example obtained by clicking on the Directors directory link 124 in the reception page of FIG. 9. Clicking on any entry in the list 130 will bring up a reception page for the respective individual.

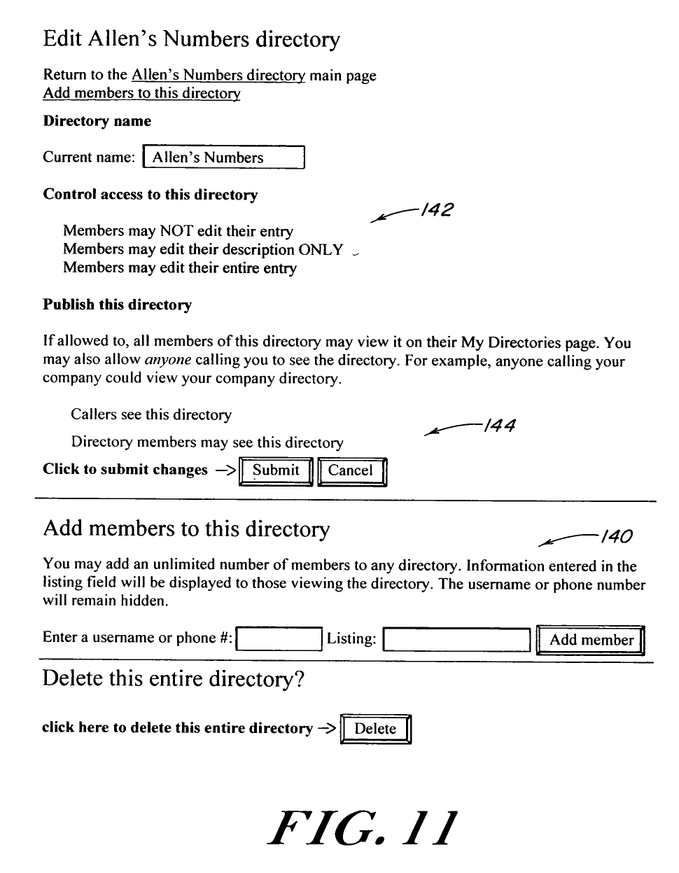

FIG. 11 shows an example of a Web page in the owner interface which provides access to properties associated with a directory. Through the Web page shown in FIG. 11, an owner can add new entries through the interface 140, determine through the interface 142 to what degree a member of the directory may edit their own entry, and through the interface 144 determine who has access to view the directory.

In one embodiment, the disclosed system is implemented as software for use in a conventional personal computer such as an IBM-PC, having a conventional operating system such as MS-Windows 2000. In such an embodiment, the source code would include a combination of HTML, VBScript, JSCRIPT, TEXT, IMAGE FILES, SQL TABLE SCHEMAS AND STORED PROCEDURES. Such an embodiment would, for example, operate when served in a web-server environment consisting of WINDOWS 2000, the IIS 5.0 Web Server, with Microsoft VBScript and JScript engines, and the Microsoft SQL Server 7 RDBMS. Additionally, such an embodiment may support Microsoft Internet Explorer 5 and above, and Netscape Navigator 5 and above, and compatible browsers.

Those skilled in the art should readily appreciate that the programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the invention may be embodied in computer software, the functions necessary to implement the invention may alternatively be embodied in part or in whole using hardware components such as Application Specific Integrated Circuits or other hardware, or some combination of hardware components and software.

While the invention is described through the above exemplary embodiments, it will be understood by those of ordinary skill in the art that modification to and variation of the illustrated embodiments may be made without departing from the inventive concepts herein disclosed. Therefore, while the preferred embodiments are described in connection with various illustrative data structures, one skilled in the art will recognize that the system may be embodied using a variety of specific data structures. Accordingly, the invention should not be viewed as limited except by the scope and spirit of the appended claims.

What is claimed is:

1. A method for providing a contact web page, comprising:
storing indication of a plurality of content items;
storing indication of at least one visitor identifier;
storing an association between a first one of said content items and a first access list;
storing an association between a second one of said content items and a second access list;
determining whether said visitor identifier is associated with said first access list;
determining whether said visitor identifier is associated with said second access list;
in the event that said visitor identifier is associated with said first access list, providing access to said first one of said content items; and
in the event that said visitor identifier is associated with said second access list, providing access to said second one of said content items.

2. The method of claim 1, wherein said first content item includes at least one hyperlink associated with a predetermined telephone number, wherein clicking on said hyperlink initiates a telephone call to said predetermined number.

3. The method of claim 1, wherein plurality of content items includes at least one directory display, wherein said directory display includes a plurality of user names and associated contact information.

4. The method of claim 1, wherein said storing of said visitor indentifier further comprises:
presenting a login interface, said login interface for entering an entered username and an entered password;
comparing said entered password with a predetermined password associated with said entered username; and
storing said entered username as said visitor identifier in the event that said entered password matches said predetermined password.

5. A system for providing a contact web page, comprising:
at least one microprocessor;
a memory communicably coupled with said microprocessor;
program code stored in said memory, wherein said program code is executable at least in part on said microprocessor, and wherein said program code is operable to
store indication of a plurality of content items;
store indication of at least one visitor identifier;
store an association between a first one of said content items and a first access list;
store an association between a second one of said content items and a second access list;
determine whether said visitor identifier is associated with said first access list;
determine whether said visitor identifier is associated with said second access list;
in the event that said visitor identifier is associated with said first access list, provide access to said first one of said content items; and
in the event that said visitor identifier is associated with said second access list, provide access to said second one of said content items.

6. The system of claim 5, wherein said first content item includes at least one hyperlink associated with a predetermined telephone number, and further comprising program code operable to initiate said telephone call to said predetermined number in response to detecting a user clicking on said hyperlink.

7. The system of claim 5, wherein plurality of content items includes at least one directory display, and further comprising program code operable to display said directory display in response to detecting a user clicking on said hyperlink, and wherein said directory display includes a plurality of user names and associated contact information.

8. The system of claim 5, wherein said program code operable to store said visitor indentifier further comprises program code operable to:
present a login interface, said login interface for entering an entered username and an entered password;
compare said entered password with a predetermined password associated with said entered username; and
store said entered username as said visitor identifier in the event that said entered password matches said predetermined password.

9. A computer program product including a computer readable medium, said computer readable medium having a computer program stored thereon, said computer program for providing a contact web page, said computer program comprising:
program code for storing indication of a plurality of content items;
program code for storing indication of at least one visitor identifier;
program code for storing an association between a first one of said content items and a first access list;
program code for storing an association between a second one of said content items and a second access list;
program code for determining whether said visitor identifier is associated with said first access list;
program code for determining whether said visitor identifier is associated with said second access list;
program code for, in the event that said visitor identifier is associated with said first access list, providing access to said first one of said content items; and
program code for, in the event that said visitor identifier is associated with said second access list, providing access to said second one of said content items.

10. A system for providing a contact web page, comprising:
means for storing indication of a plurality of content items;
means for storing indication of at least one visitor identifier;
means for storing an association between a first one of said content items and a first access list;
means for storing an association between a second one of said content items and a second access list;
means for determining whether said visitor identifier is associated with said first access list;
means for determining whether said visitor identifier is associated with said second access list;
means for, in the event that said visitor identifier is associated with said first access list, providing access to said first one of said content items; and in the event that said visitor identifier is associated with said second access list, providing access to said second one of said content items.
